(19) United States
(12) Patent Application Publication
(10) Pub. No.: US 2025/0314860 A1
(43) Pub. Date: Oct. 9, 2025

(54) CAMERA OPTICAL LENS AND LENS ASSEMBLY

(71) Applicant: Changzhou AAC Raytech Optronics Co., Ltd., Changzhou City (CN)

(72) Inventors: Congfang Si, Changzhou (CN); Wei Sun, Changzhou (CN); Shunda Zhou, Changzhou (CN)

(21) Appl. No.: 18/791,407

(22) Filed: Jul. 31, 2024

(30) Foreign Application Priority Data
Apr. 8, 2024 (CN) 202410419330.8

(51) Int. Cl. G02B 13/00; G02B 9/64

(52) U.S. Cl. CPC G02B 13/0045; G02B 9/64

(57) ABSTRACT

A camera optical lens sequentially includes seven lenses from an object side to an image side: first camera optical lens having positive refractive power, second distortion having negative refractive power, third distortion having negative refractive power, fourth lens having positive refractive power, fifth lens having negative refractive power, sixth lens having positive refractive power, and seventh lens having negative refractive power; distortion of the camera optical lens at 1.0 field of view is DIST_{1.0H}, distortion at 0.8 field of view is DIST_{0.8H}, a distortion at 0.6 field of view is DIST_{0.6H}, distortion at 0.5 field of view is DIST_{0.5H}, distortion at 0.3 field of view is DIST_{0.3H}, combined focal length of first lens, second lens, third lens, fourth lens and fifth lens is f12345, combined focal length of sixth lens and seventh lens is f67, and following relational expressions are satisfied: 0.40≤(DIST_{0.8H}−DIST_{0.5H})/(DIST_{0.5H}−DIST_{0.3H})≤1.60; −0.13≤(DIST_{1.0H}−DIST_{0.8H})/(DIST_{0.8H}−DIST_{0.6H})≤2.50; and 0.25≤f12345/f67≤2.40.

### TECHNICAL FIELD

The present disclosure relates to the field of optical lens and, in particular, to a camera optical lens and a lens assembly applicable to handheld terminal devices such as smart phones, digital cameras, and camera devices such as monitors and PC lenses, vehicle-mounted lenses.

### BACKGROUND

In recent years, with the rise of various smart devices, the demand for a miniaturized camera optical lens has gradually increased, and since the pixel size of the optical sensor is reduced, and the current electronic product tend to be light weight, thin and portable, the miniaturized camera optical lens with good imaging quality has become the mainstream of the current market. In order to obtain better imaging quality, a multi-lens structure is mostly used. In addition, with the development of technology and the increase of diversified requirements of users, under the condition that the pixel area of the optical sensor is continuously reduced and the requirements on the imaging quality of the system are continuously improved, the structure with seven lenses gradually appears in the lens design. There is an urgent need for a wide-angle camera lenses and a lens assembly having excellent optical characteristics with good processability and sufficiently corrected aberrations.

### SUMMARY

In view of the above problems, an object of the present disclosure is to provide a camera optical lens, which has good optical performance and meets design requirements of small aberration, high image quality, good processability and convenient adjustment of later image distortion.

In order to achieve the above object, a first aspect of the present disclosure provides a camera optical lens. The camera optical lens sequentially includes seven lenses from an object side to an image side: a first lens having positive refractive power, a second lens having negative refractive power, a third lens having negative refractive power, a fourth lens having positive refractive power, a fifth lens having negative refractive power, a sixth lens having positive refractive power, and a seventh lens having negative refractive power. An object-side surface of the first lens is convex in a paraxial region, an image-side surface of the first lens is concave in the paraxial region; an object-side surface of the second lens is convex in the paraxial region, an image-side surface of the second lens is concave in the paraxial region; an object-side surface of the third lens is convex in the paraxial region, an image-side surface of the third lens is concave in the paraxial region; an object-side surface of the fourth lens is convex in the paraxial region, an image-side surface of the fourth lens is convex in the paraxial region; an image-side surface of the fifth lens is concave in the paraxial region; an object-side surface of the sixth lens is convex in the paraxial region, an image-side surface of the sixth lens is concave in the paraxial region; an object-side surface of the seventh lens is convex in the paraxial region, an image-side surface of the seventh lens is concave in the paraxial region. A distortion of the camera optical lens at 1.0 field of view is defined as DIST_{1.0H}, a distortion of the camera optical lens at 0.8 field of view is defined as DIST_{0.8H}, a distortion of the camera optical lens at 0.6 field of view is defined as DIST_{0.6H}, a distortion of the camera optical lens at 0.5 field of view is defined as DIST_{0.5H}, a distortion of the camera optical lens at 0.3 field of view is defined as DIST_{0.3H}, a combined focal length of the first lens, the second lens, the third lens, the fourth lens, and the fifth lens is defined as f12345, a combined focal length of the sixth lens and the seventh lens is defined as f67, a central curvature radius of the object-side surface of the seventh lens in the paraxial region is defined as R13, a central curvature radius of the image-side surface of the seventh lens in the paraxial region is defined as R14, an abbe number of the first lens is defined as v1, a central curvature radius of the object-side surface of the third lens in the paraxial region is defined as R5, a central curvature radius of the image-side surface of the third lens in the paraxial region is defined as R6, a focal length of the camera optical lens is f, an entrance pupil diameter of the camera optical lens is defined as ENPD, a field of view of the 1.0 field of view of the camera optical lens is defined as FOV, and following relational expressions are satisfied:

$$0.4 ⩽ ( DIST 0.8 H - D IST 0.5 H ) / ( DIST 0.5 H - D IST 0.3 H ) ⩽ 1.6 ;$$

$$- 0.13 ⩽ ( DIST 1. H - D IST 0.8 H ) / ( DIST 0.8 H - D IST 0.6 H ) ⩽ 2.5 ;$$

$$0.25 ⩽ f 12345 / f 67 ⩽ 2.4 ;$$

$$1.6 ⩽ R 13 / R 14 ⩽ 3.8 ;$$

$$80. ⩽ v 1 ⩽ 82. ;$$

$$4. ⩽ ( R 5 + R 6 ) / f ⩽ 9. ; and$$

$$0.05 ⩽ E N P D / F O V ⩽ 0. 7 .$$

As an improvement, a following relational expression is satisfied: 0.40≤(DIST0.8H−DIST0.5H)/(DIST0.5H−DIST0.3H)≤1.40.

As an improvement, a following relational expression is satisfied: −0.12≤(DIST1.0H−DIST0.8H)/(DIST0.8H−DIST0.6H)≤2.10.

As an improvement, a following relational expression is satisfied: 0.25≤f12345/f67≤2.10.

As an improvement, a following relational expression is satisfied: 2.00≤R13/R14≤3.20.

As an improvement, a following relational expression is satisfied: 5.00≤(R5+R6)/f≤7.80.

As an improvement, a maximum optical radius of the object-side surface of the third lens is defined as SD31, a sagittal height at the maximum optical radius of the object-side surface of the third lens is defined as SAG31, a maximum optical radius of the object-side surface of the first lens is defined as SD11, a sagittal height at the maximum optical radius of the object-side surface of the first lens is defined as SAG11, a central curvature radius of the object-side surface of the first lens in the paraxial region is defined as R1, a central curvature radius of the object-side surface of the third lens in the paraxial region is defined as R5, and a following relational expression is satisfied: −6.60≤(SAG31/SD31*R5)/(SAG11/SD11*R1)≤−1.40.

As an improvement, a following relational expression is satisfied: −5.80≤(SAG31/SD31*R5)/(SAG11/SD11*R1)≤−1.70.

As an improvement, an on-axis thickness of the first lens is d1, an on-axis thickness of the second lens is d3, an on-axis thickness of the seventh lens is d13, and a following relational expression is satisfied:

$$1.45 ⩽ ( d 1 + d 3 + d 13 ) / d 1 ⩽ 2.25 .$$

As an improvement, a following relational expression is satisfied: 1.63≤(d1+d3+d13)/d1≤2.02.

As an improvement, the first lens is made of glass.

A second aspect of the present disclosure provides a camera optical lens. The camera optical lens sequentially includes seven lenses from an object side to an image side: a first lens having positive refractive power, a second lens having negative refractive power, a third lens having negative refractive power, a fourth lens having positive refractive power, a fifth lens having negative refractive power, a sixth lens having positive refractive power, and a seventh lens having negative refractive power. An object-side surface of the first lens is convex in a paraxial region, an image-side surface of the first lens is concave in the paraxial region; an object-side surface of the second lens is convex in the paraxial region, an image-side surface of the second lens is concave in the paraxial region; an object-side surface of the third lens is convex in the paraxial region, an image-side surface of the third lens is concave in the paraxial region; an object-side surface of the fourth lens is convex in the paraxial region, an image-side surface of the fourth lens is convex in the paraxial region; an image-side surface of the fifth lens is concave in the paraxial region; an object-side surface of the sixth lens is convex in the paraxial region, an image-side surface of the sixth lens is concave in the paraxial region; an object-side surface of the seventh lens is convex in the paraxial region, an image-side surface of the seventh lens is concave in the paraxial region. A distortion of the camera optical lens at 1.0 field of view is defined as DIST1.0H, a distortion of the camera optical lens at 0.8 field of view is defined as DIST0.8H, a distortion of the camera optical lens at 0.6 field of view is defined as DIST0.6H, a distortion of the camera optical lens at 0.5 field of view is defined as DIST0.5H, a distortion of the camera optical lens at 0.3 field of view is defined as DIST0.3H, a combined focal length of the first lens, the second lens, the third lens, the fourth lens, and the fifth lens is defined as f12345, a combined focal length of the sixth lens and the seventh lens is defined as f67, a central curvature radius of the object-side surface of the first lens in the paraxial region is defined as R1, a central curvature radius of the image-side surface of the first lens in the paraxial region is defined as R2, a central curvature radius of the object-side surface of the second lens in the paraxial region is defined as R3, a central curvature radius of the image-side surface of the second lens in the paraxial region is defined as R4, a central curvature radius of the object-side surface of the sixth lens in the paraxial region is defined as R11, a central curvature radius of the image-side surface of the sixth lens in the paraxial region is defined as R12, and following relational expressions are satisfied:

$$0.4 ⩽ ( DIST 0.8 H - D IST 0.5 H ) / ( DIST 0.5 H - D IST 0.3 H ) ⩽ 1.6 ;$$

$$- 0.13 ⩽ ( DIST 1. H - D IST 0.8 H ) / ( DIST 0.8 H - D IST 0.6 H ) ⩽ 2.5 ;$$

$$0.25 ⩽ f 12345 / f 67 ⩽ 2.4 ;$$

$$- 2.5 ⩽ ( R 1 + R 2 ) / ( R 1 - R 2 ) ⩽ - 1.5 ;$$

$$7. ⩽ ( R 3 + R 4 ) / ( R 3 - R 4 ) ⩽ 10. ; and$$

$$0.3 ⩽ R 11 / R 12 ⩽ 0.4 .$$

As an improvement, a following relational expression is satisfied: 0.40≤ (DIST0.8H−DIST0.5H)/(DIST0.5H−DIST0.3H)≤1.40.

As an improvement, a following relational expression is satisfied: −0.12≤(DIST1.0H−DIST0.8H)/(DIST0.8H−DIST0.6H)≤2.10.

As an improvement, a following relational expression is satisfied: 0.25≤f12345/f67≤2.10.

As an improvement, a following relational expression is satisfied: −2.10≤(R1+R2)/(R1−R2)≤−1.90.

As an improvement, a following relational expression is satisfied: 7.80≤(R3+R4)/(R3−R4)≤9.20.

As an improvement, a sum of lengths of air gaps between any two adjacent lenses among the first lens to the seventh lens on the optical axis is defined as Σd, a total optical length from the object-side surface of the first lens to an image surface of the camera optical lens along an optic axis of the camera optical lens is defined as TTL, and a following relational expression is satisfied:

$$0.25 ⩽ Σ d / T T L ⩽ 0.3 7 .$$

As an improvement, a following relational expression is satisfied: 0.28≤2 d/TTL≤0.33.

As an improvement, the first lens is made of glass.

A third aspect of the present disclosure provides a lens assembly. The lens assembly includes the camera optical lens as described in the first aspect above. The camera optical lens includes a first lens barrel accommodating the first lens and a second lens barrel accommodating the second lens to the seventh lens.

As an improvement, the first lens barrel includes a first top surface adjacent to an object side, the second lens barrel includes a second top surface adjacent to the object side, an object-side surface of the first lens protrudes from the first top surface toward the object side, a distance between the first top surface and a center of the object-side surface of the first lens along the optical axis is defined as B1, a distance between the second top surface and a center of the object-side surface of the first lens along the optical axis is defined as B2, a central curvature radius of the object-side surface of the first lens in the paraxial region is defined as R1, a focal length of the first lens is defined as f1, and a following relational expression is satisfied: 0.80≤(B1/B2)*(f1/R1)≤1.50.

The present disclosure has following beneficial effects: the camera optical lens according to the present disclosure has excellent optical characteristics, and has the characteristics of small aberration, high image quality, good processability and convenient adjustment of later image distortion, which is particularly suitable for a mobile phone camera lens assembly composed of camera elements such as CCD, CMOS with high definition, a WEB camera lens and a vehicle-mounted lens.

### BRIEF DESCRIPTION OF DRAWINGS

Many aspects of the exemplary embodiment can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a structural schematic diagram of a camera optical lens according to Embodiment 1 of the present disclosure;

FIG. 2 is a schematic diagram of longitudinal aberration of the camera optical lens shown in FIG. 1;

FIG. 3 is a schematic diagram of lateral color of the camera optical lens shown in FIG. 1;

FIG. 4 is a schematic diagram of field curvature and distortion of the camera optical lens shown in FIG. 1;

FIG. 5 is a structural schematic diagram of a camera optical lens according to Embodiment 2 of the present disclosure;

FIG. 6 is a schematic diagram of longitudinal aberration of the camera optical lens shown in FIG. 5;

FIG. 7 is a schematic diagram of lateral color of the camera optical lens shown in FIG. 5;

FIG. 8 is a schematic diagram of field curvature and distortion of the camera optical lens shown in FIG. 5;

FIG. 9 is a structural schematic diagram of a camera optical lens according to Embodiment 3 of the present disclosure;

FIG. 10 is a schematic diagram of longitudinal aberration of the camera optical lens shown in FIG. 9;

FIG. 11 is a schematic diagram of lateral color of the camera optical lens shown in FIG. 9;

FIG. 12 is a schematic diagram of field curvature and distortion of the camera optical lens shown in FIG. 9;

FIG. 13 is a structural schematic diagram of a camera optical lens according to Embodiment 4 of the present disclosure;

FIG. 14 is a schematic diagram of longitudinal aberration of the camera optical lens shown in FIG. 13;

FIG. 15 is a schematic diagram of lateral color of the camera optical lens shown in FIG. 13;

FIG. 16 is a schematic diagram of field curvature and distortion of the camera optical lens shown in FIG. 13; and

FIG. 17 is a structural schematic diagram of a lens assembly according to the present disclosure.

### DESCRIPTION OF EMBODIMENTS

In order to more clearly illustrate objectives, technical solutions, and advantages of the embodiments of the present disclosure, the technical solutions in the embodiments of the present disclosure are clearly and completely described in details with reference to the drawings. The described embodiments are merely part of the embodiments of the present disclosure rather than all of the embodiments. All other embodiments obtained by those skilled in the art based on the embodiments of the present disclosure shall fall into the protection scope of the present disclosure.

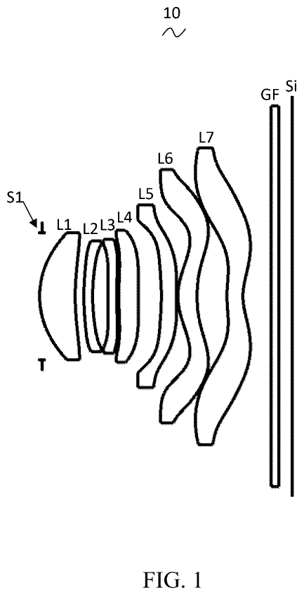

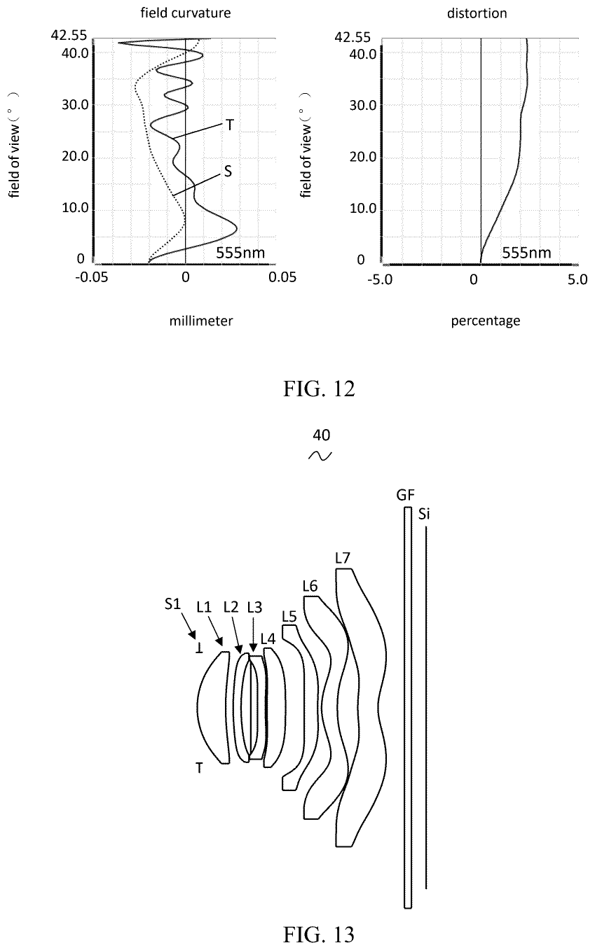

Referring to FIGS. 1-16, the technical solution of the present disclosure provides camera optical lenses 10, 20, 30 and 40. FIG. 1, FIG. 5, FIG. 9, and FIG. 13 show camera optical lenses 10, 20, 30, and 40 according to the present disclosure. The camera optical lenses 10, 20, 30, and 40 each includes seven lenses. The camera optical lens sequentially includes from an object side to an image side: an aperture; a first lens L1, a second lens L2, a third lens L3, a fourth lens L4, a fifth lens L5, a sixth lens L6 and a seventh lens L7. An optical element such as a grating filter may be provided between the seventh lens L7 and an image surface Si.

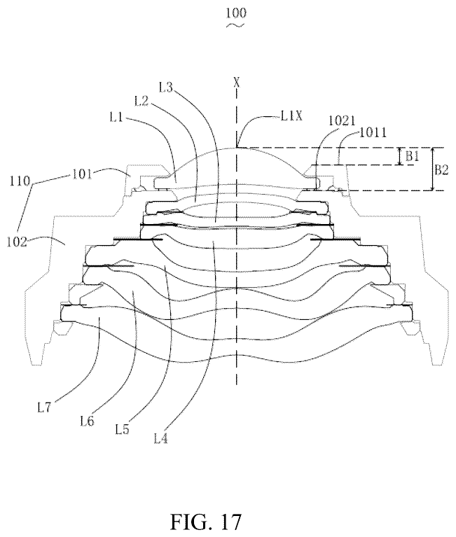

Referring to FIG. 17, the present disclosure further provides a lens assembly 100. The lens assembly 100 includes a lens barrel 110 and any camera optical lens described above accommodated in the lens barrel 110. The lens barrel 110 includes a first lens barrel 101 and a second lens barrel 102. The first lens barrel 101 and the second lens barrel 102 may be integrally formed or separately formed. The first lens barrel 101 accommodates the first lens L1, and the second lens barrel 102 accommodates the second lens L2 to the seventh lens L7. The first lens barrel 101 includes a first top surface 1011 adjacent to an object side, the second lens barrel 102 includes a second top surface 1021 adjacent to the object side, an object-side surface of the first lens L1 protrudes from the first top surface 1011 toward the object side, a distance between the first top surface 1011 and a center L1X of the object-side surface of the first lens L1 along the optical axis X is defined as B1, a distance between the second top surface 1021 and the center L1X of the object-side surface of the first lens L1 along the optical axis X is defined as B2, a central curvature radius of the object-side surface of the first lens L1 in a paraxial region is defined as R1, a focal length of the first lens L1 is defined as f1, and a following relational expression is satisfied: 0.80≤(B1/B2)*(f1/R1)≤1.50.

The first lens L1 is made of glass, the second lens L2 is made of plastic material, the third lens L3 is made of plastic material, the fourth lens L4 is made of plastic material, the fifth lens L5 is made of plastic material, the sixth lens L6 is made of plastic material, and the seventh lens L7 is made of plastic material. The glass and the resin lens are matched to reduce chromatic aberration and improve the performance of the optical camera lens. The lenses may also be made of other materials.

The object-side surface and the image-side surface of the first lens L1, the second lens L2, the third lens L3, the fourth lens L4, the fifth lens L5, the sixth lens L6, and the seventh lens L7 are aspheric surfaces.

An object-side surface of the first lens L1 is convex in the paraxial region, an image-side surface of the first lens L1 is concave in the paraxial region, and the first lens L1 has positive refractive power. The object-side surface and the image-side surface of the first lens L1 may also be provided with other concave and convex distributions.

An object-side surface of the second lens L2 is convex in the paraxial region, an image-side surface of the second lens L2 is concave in the paraxial region, and the first lens L2 has negative refractive power. The object-side surface and the image-side surface of the first lens L2 may also be provided with other concave and convex distributions.

An object-side surface of the third lens L3 is convex in the paraxial region, an image-side surface of the third lens L3 is convex in the paraxial region, and the third lens L3 has negative refractive power. The object-side surface and the image-side surface of the third lens L3 may also be provided with other concave and convex distributions.

An object-side surface of the fourth lens L4 is convex in the paraxial region, an image-side surface of the fourth lens L4 is convex in the paraxial region, and the fourth lens L4 has positive refractive power. The object-side surface and the image-side surface of the fourth lens L4 may also be provided with other concave and convex distributions.

An object-side surface of the fifth lens L5 is convex or concave in the paraxial region, an image-side surface of the fifth lens L5 is concave in the paraxial region, and the fifth lens L5 has negative refractive power. The object-side surface and the image-side surface of the fifth lens L5 may also be provided with other concave and convex distributions.

An object-side surface of the sixth lens L6 is concave in the paraxial region, an image-side surface of the sixth lens L6 is convex in the paraxial region, and the sixth lens L6 has positive refractive power. The object-side surface and the image-side surface of the sixth lens L6 may also be provided with other concave and convex distributions.

An object-side surface of the seventh lens L7 is convex in the paraxial region, an image-side surface of the seventh lens L7 is concave in the paraxial region, and the seventh lens L7 has negative refractive power. The object-side surface and the image-side surface of the seventh lens L7 may also be provided with other concave and convex distributions.

A distortion of the camera optical lens at 0.8 field of view is defined as DIST_{0.8H}, a distortion of the camera optical lens at 0.5 field of view is defined as DIST_{0.5H}, a distortion of the camera optical lens at 0.3 field of view is defined as DIST_{0.3H}, and a following relational expression is satisfied: 0.40≤(DIST_{0.8}H−DIST_{0.5H})/(DIST_{0.5H}−DIST_{0.3H})≤1.60. Within the range of the relational expression, it is beneficial to optimize the distortion curve. In the later image processing, it is easy to match the distortion correction formula to improve the distortion correction effect and reduce the image distortion, distortion=(actual image height-ideal image height)/ideal image height*100%. As an improvement, 0.40≤(DIST_{0.8H}−DIST_{0.5H})/(DIST_{0.5H}−DIST_{0.3H})≤1.40.

A distortion of the camera optical lens at 1.0 field of view is defined as DIST_{1.0H}, a distortion of the camera optical lens at 0.8 field of view is defined as DIST_{0.8H}, a distortion of the camera optical lens at 0.6 field of view is defined as DIST_{0.6H}, and a following relational expression is satisfied: −0.13≤(DIST_{1.0H}−DIST_{0.8H})/(DIST_{0.8H}-DIST_{0.6H})≤2.50. Within the range of the relational expression, it is beneficial to optimize the distortion curve. In the later image processing, it is easy to match the distortion correction formula to improve the distortion correction effect and reduce the image distortion. As an improvement, −0.12≤(DIST_{1.0H}−DIST_{0.8H})/(DIST_{0.8H}−DIST_{0.6H})≤2.10.

A combined focal length of the first lens, the second lens, the third lens, the fourth lens and the fifth lens is defined as f12345, a combined focal length of the sixth lens and the seventh lens is defined as f67, and a following relational expression is satisfied: 0.25≤f12345/f67≤2.40. Within the range of the relational expression, it is beneficial to the reasonable distribution of the refractive power of each lens in space and reduce the aberration of the optical system by reasonably configuring a proportional relationship between the combined focal length of the sixth lens and the seventh lens and the combined focal length of the first lens, the second lens, the third lens, the fourth lens and the fifth lens. As an improvement, 0.25≤f12345/f67≤2.10.

A central curvature radius of an object-side surface of the seventh lens in the paraxial region is defined as R13, a central curvature radius of an image-side surface of the seventh lens in the paraxial region is defined as R14, and a following relational expression is satisfied: 1.60≤R13/R14≤3.80, by controlling the ratio of the central curvature radius of the object-side surface of the seventh lens in the paraxial region to the central curvature radius of the image-side surface of the seventh lens in the paraxial region. Within the range of the relational expression, the processability of the seventh lens is achieved, the aberration of the system is reduced, and the image quality is improved. As an improvement, 2.00≤R13/R14≤3.20.

An abbe number of the first lens is defined as v1, and a following relational expression is satisfied: 80.00≤v1≤82.00, by controlling the abbe number of the first lens within the range, the purpose of controlling the overall chromatic aberration of the system is achieved. The material with low refractive index and high abbe number is applied to design, and better performance of the camera lens may be achieved by using the characteristics of the material, so that the market demand is better met.

A central curvature radius of the object-side surface of the third lens in the paraxial region is defined as R5, a central curvature radius of the image-side surface of the third lens in the paraxial region is defined as R6, a focal length of the camera optical lens is f, and a following relational expression is satisfied: 4.00≤(R5+R6)/f≤9.00, a ratio of the sum of the central curvature radius of the object-side surface and the image-side surface of the third lens to the effective focal length of the camera optical lens is reasonably configured, which may make the optical imaging lens have a small enough lateral color, and achieve that the optical imaging lens is not easy to appear purple and yellow edges during shooting. As an improvement, 5.00≤(R5+R6)/f≤7.80.

An entrance pupil diameter of the camera optical lens is defined as ENPD, the field of view of the 1.0 field of view of the camera optical lens is defined as FOV, and a following relational expression is satisfied: 0.05≤ENPD/FOV≤0.07, it may achieve a small FNO lens, increase the light flux and meet the requirement of wide-angle by limiting the ENPD and the FOV within a reasonable range.

A maximum optical radius of the object-side surface of the third lens is defined as SD31, a sagittal height at the maximum optical radius of the object-side surface of the third lens is defined as SAG31, a maximum optical radius of the object-side surface of the first lens is defined as SD11, a sagittal height at the maximum optical radius of the object-side surface of the first lens is defined as SAG11, a central curvature radius of the object-side surface of the first lens in the paraxial region is defined as R1, a central curvature radius of the object-side surface of the third lens in the paraxial region is R5, and a following relational expression is satisfied: −6.60≤(SAG31/SD31*R5)/(SAG11/SD11*R1)≤−1.40. Within the range of the relational expression, both the object-side surface of the first lens and the object-side surface of the third lens have a gentle surface shape, which reduces the assembly sensitivity of the camera optical lens. As an improvement, −5.80≤(SAG31/SD31*R5)/(SAG11/SD11*R1)≤−1.70. The maximum optical radius refers to the maximum radius reached by the MIC field of view light on the lens surface; the sagittal height refers to the distance from the point on the surface to the surface center point on the optical axis along the optical axis, which is positive on the right side of the center point and negative on the left side of the center point.

An on-axis thickness of the first lens is defined as d1, an on-axis thickness of the second lens is defined as d3, an on-axis thickness of the seventh lens is defined as d13, and a following relational expression is satisfied: 1.45≤(d1+d3+d13)/d1≤2.25, it is beneficial to achieve ultra-thinness by reasonably controlling the on-axis thicknesses of the first lens, the second lens and the seventh lens. As an improvement, 1.63≤(d1+d3+d13)/d1≤2.02.

A central curvature radius of the object-side surface of the first lens is defined as R1 in the paraxial region, a central curvature radius of the image-side surface of the first lens is defined as R2 in the paraxial region, and a following relational expression is satisfied: −2.50≤(R1+R2)/(R1−R2)≤−1.50, the shape of the first lens is reasonably controlled, the surface type and refractive power of the first lens may be adjusted, which is beneficial to receive light with a larger viewing angle. As an improvement, −2.10≤(R1+R2)/(R1−R2)≤−1.90.

A central curvature radius of the object-side surface of the second lens in the paraxial region is defined as R3, a central curvature radius of the image-side surface of the second lens in the paraxial region is defined as R4, and a following relational expression is satisfied: 7.00≤(R3+R4)/(R3−R4)≤10.00, which may achieve the processability of the shape of the second lens, and may effectively control the aberration generated by the mobile camera module at the second lens. As an improvement, 7.80≤(R3+R4)/(R3−R4)≤9.20.

A sum of lengths of air gap between any two adjacent lenses among the first lens to the seventh lens on the optical axis is defined as Σd, a total optical length from the object-side surface of the first lens to an image surface of the camera optical lens along an optic axis of the camera optical lens is defined as TTL, and a following relational expression is satisfied: 0.25≤Ed/TTL≤0.37. Within the range of the relational expression, a ratio of a sum of air gaps between two adjacent lenses on the optical axis to a total optical length is reasonably controlled to achieve ultra-thinness. As an improvement, 0.28≤Ed/TTL≤0.33.

Compared with the related art, the camera optical lens provided by the present disclosure is configured with 0.40≤(DIST_{0.8H}−DIST_{0.5H})/(DIST_{0.5H}−DIST_{0.3H})≤1.60; −0.13≤(DIST_{1.0H}−DIST_{0.8H})/(DIST_{0.8H}−DIST_{0.6H})≤2.50; 0.25≤f12345/f67≤2.40; 1.60≤R13/R14≤3.80; 80.00≤v1≤82.00; 4.00≤(R5+R6)/f≤9.00; and 0.05≤ENPD/FOV≤0.07, which may optimize the distortion curve, easily match the distortion correction formula in later image processing, improve the distortion correction effect, and reduce the image distortion. It is beneficial to the reasonable distribution of the refractive power of each lens in space, and reduce the aberration of the optical system. It may achieve the processability of the seventh lens, reduce the aberration of the system, and improve the image quality. In addition, the overall chromatic aberration of the system may be controlled, and better performance of the camera lens is achieved by using the characteristics of the material. It may make the optical imaging lens have a small enough lateral color, and achieve that the optical imaging lens is not easy to appear purple and yellow edges during shooting. It may achieve a small FNO lens, increase the light flux and meet the requirement of wide-angle.

Compared with the related art, the camera optical lens provided by the present disclosure is configured with 0.40≤(DIST_{0.8H}−DIST_{0.5H})/(DIST_{0.5H}−DIST_{0.3H})≤1.60; −0.13≤(DIST_{1.0H}−DIST_{0.8H})/(DIST_{0.8H}−DIST_{0.6H})≤2.50; 0.25≤f12345/f67≤2.40; −2.50≤(R1+R2)/(R1−R2)≤−1.50; 7.00≤(R3+R4)/(R3−R4)≤10.00; and 0.30≤R11/R12≤0.40, which may optimize the distortion curve, easily match the distortion correction formula in later image processing, improve the distortion correction effect, and reduce the image distortion. It is beneficial to the reasonable distribution of the refractive power of each lens in space, and reduce the aberration of the optical system. It may achieve the processability of the seventh lens, reduce the aberration of the system, and improve the image quality. In addition, it is also helpful to receive light of a larger viewing angle. The processability of the shape of the second lens may be achieved, and the aberration generated by the mobile camera module at the second lens may be effectively controlled. The surface shape of the sixth lens may cooperate with the fifth lens to correct the off-axis aberration, and stray light generated at the image side end may be avoided, so that the illumination of the imaging surface and the imaging quality are improved.

The camera optical lens of the present disclosure will be described below with examples. The reference signs recited in each example are shown below. The units of focal length, on-axis distance, central curvature radius and on-axis thickness are mm.

TTL: total optical length (an on-axis distance from the object-side surface of the first lens L1 to the image surface Si), in mm.

F-number FNO: refers to the ratio of the effective focal length of the camera optical lens to the entrance pupil diameter of the camera optical lens.

The technical solutions of the present disclosure will be described in detail in four embodiments.

### Embodiment 1

Table 1 and Table 2 show design data of the camera optical lens 10 according to Embodiment 1 of the present disclosure.

TABLE 1

| | R | d | | nd | | νd | |
|---|---|---|---|---|---|---|---|
| S1 | ∞ | d0= | −0.090 | | | | |
| R1 | 3.457 | d1= | 1.414 | nd1 | 1.4959 | ν1 | 81.65 |
| R2 | 9.881 | d2= | 0.345 | | | | |
| R3 | 9.700 | d3= | 0.349 | nd2 | 1.6700 | ν2 | 19.39 |
| R4 | 7.771 | d4= | 0.600 | | | | |
| R5 | 31.799 | d5= | 0.351 | nd3 | 1.6700 | ν3 | 19.39 |
| R6 | 15.254 | d6= | 0.090 | | | | |
| R7 | 17.101 | d7= | 0.784 | nd4 | 1.5444 | ν4 | 55.82 |
| R8 | −103.160 | d8= | 0.905 | | | | |
| R9 | −8.538 | d9= | 0.604 | nd5 | 1.5661 | ν5 | 37.71 |
| R10 | 28.498 | d10= | 0.052 | | | | |
| R11 | 2.395 | d11= | 0.767 | nd6 | 1.5346 | ν6 | 55.69 |
| R12 | 6.888 | d12= | 1.186 | | | | |
| R13 | 4.993 | d13= | 0.636 | nd7 | 1.5346 | ν7 | 55.69 |
| R14 | 2.395 | d14= | 1.115 | | | | |
| R15 | ∞ | d15= | 0.310 | Ndg | 1.5168 | νg | 64.17 |
| R16 | ∞ | d16= | 0.533 | | | | |

The meaning of each reference sign is as follows.
S1: aperture;
R: curvature radius at the center of the optical plane;
R1: central curvature radius of the object-side surface of the first lens L1 in the paraxial region;
R2: central curvature radius of the image-side surface of the first lens L1 in the paraxial region;
R3: central curvature radius of the object-side surface of the second lens L2 in the paraxial region;
R4: central curvature radius of the image-side surface of the second lens L2 in the paraxial region;
R5: central curvature radius of the object-side surface of the third lens L3 in the paraxial region;
R6: central curvature radius of the image-side surface of the third lens L3 in the paraxial region;
R7: central curvature radius of the object-side surface of the fourth lens L4 in the paraxial region;
R8: central curvature radius of the image-side surface of the fourth lens L4 in the paraxial region;
R9: central curvature radius of the object-side surface of the fifth lens L5 in the paraxial region;
R10: central curvature radius of the image-side surface of the fifth lens L5 in the paraxial region;
R11: central curvature radius of the object-side surface of the sixth lens L6 in the paraxial region;
R12: central curvature radius of the image-side surface of the sixth lens L6 in the paraxial region;
R13: central curvature radius of the object-side surface of the seventh lens L7 in the paraxial region;
R14: central curvature radius of the image-side surface of the seventh lens L7 in the paraxial region;
R15: central curvature radius of the object-side surface of the grating filter GF in the paraxial region;
R16: central curvature radius of the image-side surface of the grating filter GF in the paraxial region;
d: on-axis thickness of lenses, on-axis distance between lenses;
d0: on-axis distance from the aperture S1 to the object-side surface of the first lens L1;
d1: on-axis thickness of the first lens L1;
d2: on-axis distance from the image-side surface of the first lens L1 to the object-side surface of the second lens L2;
d3: on-axis thickness of the second lens L2;
d4: on-axis distance from the image-side surface of the second lens L2 to the object-side surface of the third lens L3;
d5: on-axis thickness of the third lens L3;
d6: on-axis distance from the image-side surface of the third lens L3 to the object-side surface of the fourth lens L4;
d7: on-axis thickness of the fourth lens L4;
d8: on-axis distance from the image-side surface of the fourth lens L4 to the object-side surface of the fifth lens L5;
d9: on-axis thickness of the fifth lens L5;
d10: on-axis distance from the image-side surface of the fifth lens L5 to the object-side surface of the sixth lens L6;
d11: on-axis thickness of the sixth lens L6;
d12: on-axis distance from the image-side surface of the sixth lens L6 to the object-side surface of the seventh lens L7;
d13: on-axis thickness of the seventh lens L7;
d14: on-axis distance from the image-side surface of the seventh lens L7 to the object-side surface of the grating filter GF;
d15: on-axis thickness of the grating filter GF;
d16: on-axis distance from the image-side surface of the grating filter GF to the image surface Si;
nd: refractive index of d line (the d line is green light with a wavelength of 550 nm);
nd1: refractive index of d line of the first lens L1;
nd2: refractive index of d line of the second lens L2;
nd3: refractive index of d line of the third lens L3;
nd4: refractive index of d line of the fourth lens L4;
nd5: refractive index of d line of the fifth lens L5;
nd6: refractive index of d line of the sixth lens L6;
nd7: refractive index of d line of the seventh lens L7;
ndg: refractive index of d line of the grating filter GF;
vd: abbe number;
v1: abbe number of the first lens L1;
v2: abbe number of the second lens L2;
v3: abbe number of the third lens L3;
v4: abbe number of the fourth lens L4;
v5: abbe number of the fifth lens L5;
v6: abbe number of the sixth lens L6;
v7: abbe number of the seventh lens L7; and
vg: abbe number of the grating filter GF.

Table 2 shows aspheric surface data of each lens in the camera optical lens 10 according to Embodiment 1 of the present disclosure.

TABLE 2

| | Conic Coefficient | Aspheric Coefficient | | | | |
|---|---|---|---|---|---|---|
| | k | A4 | A6 | A8 | A10 | A12 |
| R1 | 0.0000E+00 | 2.8930E−03 | −6.7072E−03 | 7.2002E−03 | −4.4400E−03 | 1.6548E−03 |
| R2 | 0.0000E+00 | −6.9167E−04 | −6.1840E−03 | 6.3387E−03 | −3.9220E−03 | 1.5283E−03 |
| R3 | 0.0000E+00 | −5.3742E−03 | −4.1540E−03 | 5.1888E−03 | −2.9979E−03 | 1.1334E−03 |
| R4 | 0.0000E+00 | −1.2611E−03 | −8.6298E−03 | 1.2939E−02 | −1.0515E−02 | 5.4697E−03 |
| R5 | 0.0000E+00 | −5.3772E−03 | 1.6618E−05 | −2.9517E−03 | 2.2434E−03 | −9.6378E−04 |
| R6 | 0.0000E+00 | −1.4440E−03 | 3.8437E−05 | −9.2895E−03 | 9.7438E−03 | −5.2526E−03 |
| R7 | 0.0000E+00 | 2.4792E−03 | −1.1227E−02 | 4.7130E−03 | −6.0636E−04 | −3.3843E−04 |
| R8 | 0.0000E+00 | −9.9261E−04 | −2.9100E−03 | −5.3556E−04 | 8.5346E−04 | −3.5468E−04 |
| R9 | −1.0000E+00 | 2.6177E−02 | −1.1365E−02 | 6.4553E−04 | 2.3321E−03 | −1.5321E−03 |
| R10 | −1.0000E+00 | −3.3066E−02 | −4.9284E−04 | 6.5174E−03 | −3.6588E−03 | 1.1243E−03 |
| R11 | −6.0000E+00 | 5.0635E−03 | −5.3391E−03 | 1.7041E−03 | −5.2520E−04 | 1.1500E−04 |
| R12 | −1.0000E+00 | 3.1821E−02 | −1.3721E−02 | 2.8997E−03 | −4.3372E−04 | 4.6373E−05 |
| R13 | −1.0000E+00 | −5.9057E−02 | 1.0294E−02 | −1.2382E−03 | 8.8635E−05 | −3.5567E−07 |
| R14 | −1.0000E+00 | −6.9201E−02 | 1.6450E−02 | −3.4017E−03 | 5.5547E−04 | −6.9006E−05 |
| | Conic Coefficient | Aspheric Coefficient | | | | |
| | k | A14 | A16 | A18 | A20 | A22 |
| R1 | 0.0000E+00 | −3.7992E−04 | 5.2451E−05 | −3.9932E−06 | 1.2875E−07 | 0.0000E+00 |
| R2 | 0.0000E+00 | −3.7466E−04 | 5.5845E−05 | −4.6141E−06 | 1.6181E−07 | 0.0000E+00 |
| R3 | 0.0000E+00 | −2.6612E−04 | 3.6357E−05 | −2.5287E−06 | 6.3112E−08 | 0.0000E+00 |
| R4 | 0.0000E+00 | −1.7916E−03 | 3.5838E−04 | −4.0107E−05 | 1.9344E−06 | 0.0000E+00 |
| R5 | 0.0000E+00 | 2.3423E−04 | −2.7928E−05 | 6.8853E−07 | 1.0479E−07 | 0.0000E+00 |
| R6 | 0.0000E+00 | 1.6656E−03 | −3.1141E−04 | 3.1723E−05 | −1.3545E−06 | 0.0000E+00 |
| R7 | 0.0000E+00 | 1.9408E−04 | −4.3539E−05 | 4.6716E−06 | −1.9548E−07 | 0.0000E+00 |
| R8 | 0.0000E+00 | 7.8793E−05 | −9.8273E−06 | 6.2591E−07 | −1.4988E−08 | 0.0000E+00 |
| R9 | −1.0000E+00 | 4.5932E−04 | −5.8155E−05 | −5.6955E−06 | 3.6198E−06 | −6.7957E−07 |
| R10 | −1.0000E+00 | −2.2043E−04 | 2.8258E−05 | −2.2849E−06 | 9.9743E−08 | −3.2830E−10 |
| R11 | −6.0000E+00 | −1.6380E−05 | 1.4757E−06 | −7.9845E−08 | 2.1953E−09 | −5.5241E−12 |
| R12 | −1.0000E+00 | −3.1841E−06 | 7.1361E−08 | 1.1284E−08 | −1.4823E−09 | 9.2105E−11 |
| R13 | −1.0000E+00 | −6.5153E−07 | 7.4722E−08 | −4.6700E−09 | 1.8905E−10 | −5.1264E−12 |
| R14 | −1.0000E+00 | 6.3898E−06 | −4.3583E−07 | 2.1748E−08 | −7.8814E−10 | 2.0460E−11 |

| | Conic Coefficient | Aspheric Coefficient | | | | |
|---|---|---|---|---|---|---|
| | k | A24 | A26 | A28 | A30 | / |
| R1 | 0.0000E+00 | 0.0000E+00 | 0.0000E+00 | 0.0000E+00 | 0.0000E+00 | / |
| R2 | 0.0000E+00 | 0.0000E+00 | 0.0000E+00 | 0.0000E+00 | 0.0000E+00 | / |
| R3 | 0.0000E+00 | 0.0000E+00 | 0.0000E+00 | 0.0000E+00 | 0.0000E+00 | / |
| R4 | 0.0000E+00 | 0.0000E+00 | 0.0000E+00 | 0.0000E+00 | 0.0000E+00 | / |
| R5 | 0.0000E+00 | 0.0000E+00 | 0.0000E+00 | 0.0000E+00 | 0.0000E+00 | / |
| R6 | 0.0000E+00 | 0.0000E+00 | 0.0000E+00 | 0.0000E+00 | 0.0000E+00 | / |
| R7 | 0.0000E+00 | 0.0000E+00 | 0.0000E+00 | 0.0000E+00 | 0.0000E+00 | / |
| R8 | 0.0000E+00 | 0.0000E+00 | 0.0000E+00 | 0.0000E+00 | 0.0000E+00 | / |
| R9 | −1.0000E+00 | 7.1390E−08 | −4.4638E−09 | 1.5564E−10 | −2.3377E−12 | / |
| R10 | −1.0000E+00 | −2.1154E−10 | 1.1263E−11 | −2.5145E−13 | 2.1040E−15 | / |
| R11 | −6.0000E+00 | −1.0887E−12 | 4.7379E−15 | 7.9993E−16 | −1.3225E−17 | / |
| R12 | −1.0000E+00 | −3.4813E−12 | 8.1510E−14 | −1.0932E−15 | 6.4502E−18 | / |
| R13 | −1.0000E+00 | 9.1385E−14 | −9.9960E−16 | 5.6897E−18 | −1.0269E−20 | / |
| R14 | −1.0000E+00 | −3.7028E−13 | 4.4347E−15 | −3.1589E−17 | 1.0135E−19 | / |

For convenience, the aspheric surface of each lens surface uses the aspheric surface shown in following formula (1). However, the present disclosure is not limited to the aspheric polynomial form shown in formula (1).

$$z = ( c {r}^{2} ) / \{ 1 + {[ 1 - ( k + 1 ) ( {c}^{2} {r}^{2} ) ]}^{1 / 2} \} + A 4 {r}^{4} + A 6 {r}^{6} + A 8 {r}^{8} + A 10 {r}^{10} + A 12 {r}^{12} + A 14 {r}^{14} + A 16 {r}^{16} + A 18 {r}^{18} + A 20 {r}^{20} + A 22 {r}^{22} + A 24 {r}^{24} + A 26 {r}^{26} + A 28 {r}^{28} + A 30 {r}^{30} \qquad ( 1 )$$

Where, k is a conic coefficient, A4, A6, A8, A10, A12, A14, A16, A18, A20, A22, A24, A26, A28 and A30 are aspheric coefficients, c is a curvature at a center of an optical surface, r is a vertical distance between a point on an aspheric curve and an optical axis, and z is an aspheric depth (a vertical distance between a point on the aspheric surface and the optical axis, where r is a distance from the point on the aspheric surface to the optical axis, and a vertical distance between the point on the aspheric surface and a tangent plane tangent to a vertex on the aspheric optical axis).

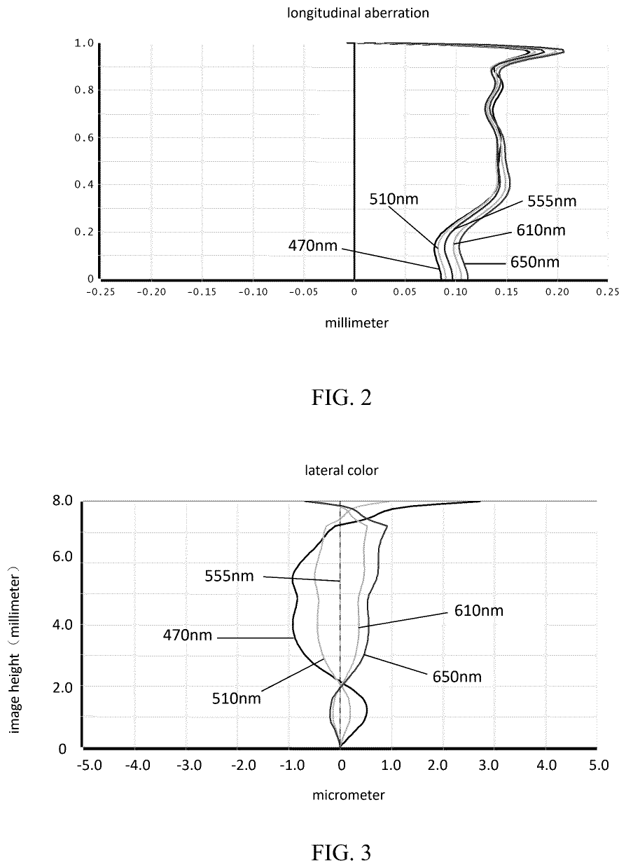

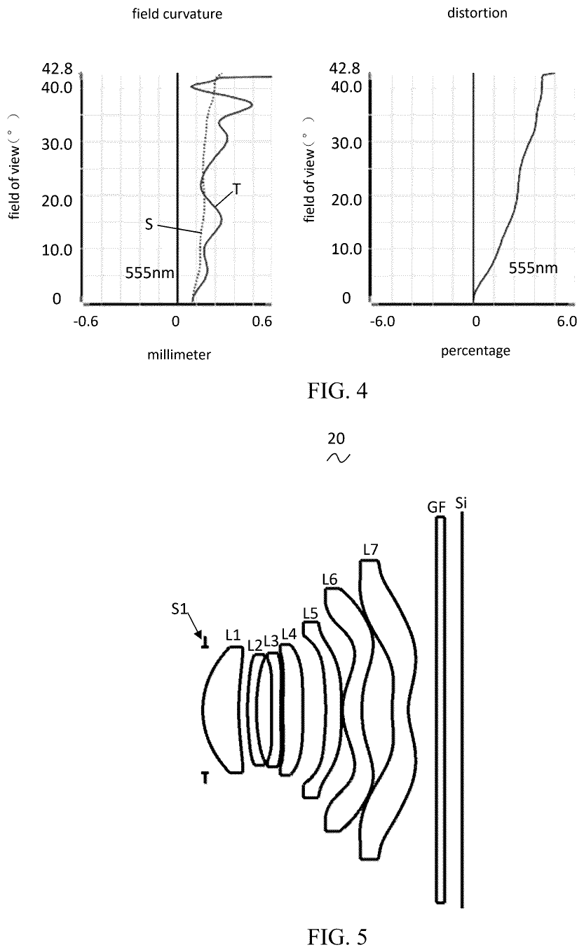

FIG. 2 and FIG. 3 respectively show longitudinal aberration and lateral color of light with wavelengths of 650 nm, 610 nm, 555 nm, 510 nm, and 470 nm after passing through the camera optical lens 10 according to Embodiment 1. FIG. 4 shows field curvature and distortion of light with a wavelength of 555 nm after passing through the camera optical lens 10 according to Embodiment 1, the field curvature S in FIG. 4 is a field curvature in the sagittal direction, and T is a field curvature in the meridian direction.

In this embodiment, the entrance pupil diameter ENPD of the camera optical lens 10 is 5.136 mm, the full field of view (1.0 field of view) image height IH is 8.000 mm, the FOV in a diagonal direction of the full field of view (1.0 field of view) is 85.58°, MIC field of view image height IH is 8.250 mm, and field of view FOV of MIC field of view in the diagonal is 87.71°. The camera optical lens 10 meets the design requirements of small aberration, high image quality, good processability and convenient adjustment of later image distortion, its on-axis and off-axis chromatic aberrations are sufficiently corrected. The camera optical lens 10 has excellent optical characteristics.

It may be understood that the 1.0 field of view image height refers to half of the diagonal length of an effective pixel area of the sensor; the MIC field of view image height refers to a field of view height that is expanded from the 1.0 field of view image height and is used to prevent assembly deviation; the FOV in a diagonal direction of the 1.0 field of view refers to the field of view corresponding to the effective pixel area of the sensor; and the FOV in a diagonal direction of the MIC field of view refers to a field of view corresponding to the MIC field of view image height.

### Embodiment 2

The meaning of the reference signs of Embodiment 2 is the same as that of Embodiment 1.

FIG. 5 shows a camera optical lens 20 according to Embodiment 2 of the present disclosure.

Table 3 and Table 4 show design data of the camera optical lens 20 according to Embodiment 2 of the present disclosure.

TABLE 3

| | R | d | | nd | | νd | |
|---|---|---|---|---|---|---|---|
| S1 | ∞ | d0= | −0.090 | | | | |
| R1 | 3.472 | d1= | 1.414 | nd1 | 1.4959 | ν1 | 81.65 |
| R2 | 10.621 | d2= | 0.345 | | | | |
| R3 | 9.236 | d3= | 0.349 | nd2 | 1.6700 | ν2 | 19.39 |
| R4 | 7.333 | d4= | 0.600 | | | | |
| R5 | 46.241 | d5= | 0.351 | nd3 | 1.6700 | ν3 | 19.39 |
| R6 | 17.919 | d6= | 0.090 | | | | |
| R7 | 17.681 | d7= | 0.784 | nd4 | 1.5444 | ν4 | 55.82 |
| R8 | −101.816 | d8= | 0.905 | | | | |
| R9 | −8.495 | d9= | 0.604 | nd5 | 1.5661 | ν5 | 37.71 |
| R10 | 26.468 | d10= | 0.052 | | | | |
| R11 | 2.368 | d11= | 0.767 | nd6 | 1.5346 | ν6 | 55.69 |
| R12 | 6.995 | d12= | 1.186 | | | | |
| R13 | 4.894 | d13= | 0.636 | nd7 | 1.5346 | ν7 | 55.69 |
| R14 | 2.388 | d14= | 1.115 | | | | |
| R15 | ∞ | d15= | 0.310 | ndg | 1.5168 | νg | 64.17 |
| R16 | ∞ | d16= | 0.691 | | | | |

Table 4 shows aspheric surface data of each lens in the camera optical lens 20 according to Embodiment 2 of the present disclosure.

TABLE 4

| | Conic Coefficient | Aspheric Coefficient | | | | |
|---|---|---|---|---|---|---|
| | k | A4 | A6 | A8 | A10 | A12 |
| R1 | 3.9108E−02 | 2.9588E−03 | −7.0759E−03 | 7.3993E−03 | −4.3936E−03 | 1.5784E−03 |
| R2 | 1.4384E+00 | −1.3320E−03 | −5.3740E−03 | 5.9864E−03 | −3.7839E−03 | 1.4640E−03 |
| R3 | −5.1254E−01 | −5.5340E−03 | −3.6184E−03 | 4.7766E−03 | −2.9949E−03 | 1.2265E−03 |
| R4 | −9.1475E−02 | 1.6023E−05 | −1.1314E−02 | 1.5908E−02 | −1.2366E−02 | 5.9951E−03 |
| R5 | 9.7886E+01 | −7.6047E−03 | 6.5449E−03 | −9.1483E−03 | 5.7133E−03 | −2.1398E−03 |
| R6 | 1.1659E+01 | −5.3066E−03 | 7.8360E−03 | −1.6299E−02 | 1.3462E−02 | −6.3099E−03 |
| R7 | −8.4469E−01 | −2.5614E−03 | −5.0938E−03 | −2.9931E−04 | 2.1554E−03 | −1.2437E−03 |
| R8 | 1.0117E+03 | −2.3989E−03 | −1.2762E−03 | −1.8782E−03 | 1.4219E−03 | −4.4551E−04 |
| R9 | −1.2442E+00 | 2.7773E−02 | −1.4725E−02 | 2.8284E−03 | 1.5735E−03 | −1.3760E−03 |
| R10 | −2.8692E+01 | −3.1516E−02 | −1.6832E−03 | 6.9268E−03 | −3.7303E−03 | 1.1304E−03 |
| R11 | −6.2557E+00 | 7.3876E−03 | −6.2927E−03 | 1.9248E−03 | −5.5120E−04 | 1.1625E−04 |
| R12 | −1.1420E+00 | 3.0945E−02 | −1.3470E−02 | 2.8651E−03 | −4.3058E−04 | 4.6190E−05 |
| R13 | −1.0994E+00 | −5.7763E−02 | 9.8890E−03 | −1.1842E−03 | 8.5073E−05 | −2.5345E−07 |
| R14 | −9.9551E−01 | −6.7599E−02 | 1.6207E−02 | −3.3868E−03 | 5.5517E−04 | −6.9008E−05 |
| | Conic Coefficient | Aspheric Coefficient | | | | |
| | k | A14 | A16 | A18 | A20 | A22 |
| R1 | 3.9108E−02 | −3.5112E−04 | 4.7292E−05 | −3.5370E−06 | 1.1270E−07 | 0.0000E+00 |
| R2 | 1.4384E+00 | −3.5237E−04 | 5.1568E−05 | −4.2122E−06 | 1.4750E−07 | 0.0000E+00 |
| R3 | −5.1254E−01 | −3.1441E−04 | 4.8777E−05 | −4.1949E−06 | 1.5408E−07 | 0.0000E+00 |
| R4 | −9.1475E−02 | −1.8120E−03 | 3.3364E−04 | −3.4334E−05 | 1.5194E−06 | 0.0000E+00 |
| R5 | 9.7886E+01 | 4.5417E−04 | −4.4438E−05 | 1.4399E−07 | 2.0321E−07 | 0.0000E+00 |
| R6 | 1.1659E+01 | 1.7606E−03 | −2.8677E−04 | 2.5013E−05 | −8.9587E−07 | 0.0000E+00 |
| R7 | −8.4469E−01 | 3.3938E−04 | −4.6449E−05 | 2.6788E−06 | −2.3601E−08 | 0.0000E+00 |
| R8 | 1.0117E+03 | 6.9637E−05 | −4.4468E−06 | −7.7642E−08 | 1.6128E−08 | 0.0000E+00 |
| R9 | −1.2442E+00 | 4.4136E−04 | −5.7563E−05 | −5.5874E−06 | 3.6154E−06 | −6.8212E−07 |
| R10 | −2.8692E+01 | −2.2069E−04 | 2.8278E−05 | −2.2874E−06 | 9.9763E−08 | −3.1051E−10 |
| R11 | −6.2557E+00 | −1.6364E−05 | 1.4730E−06 | −7.9914E−08 | 2.2061E−09 | −5.6909E−12 |
| R12 | −1.1420E+00 | −3.1767E−06 | 7.0770E−08 | 1.1345E−08 | −1.4851E−09 | 9.2104E−11 |
| R13 | −1.0994E+00 | −6.5136E−07 | 7.4662E−08 | −4.6699E−09 | 1.8907E−10 | −5.1262E−12 |
| R14 | −9.9551E−01 | 6.3897E−06 | −4.3580E−07 | 2.1747E−08 | −7.8814E−10 | 2.0460E−11 |

| | Conic Coefficient | Aspheric Coefficient | | | | |
|---|---|---|---|---|---|---|
| | k | A24 | A26 | A28 | A30 | / |
| R1 | 3.9108E−02 | 0.0000E+00 | 0.0000E+00 | 0.0000E+00 | 0.0000E+00 | / |
| R2 | 1.4384E+00 | 0.0000E+00 | 0.0000E+00 | 0.0000E+00 | 0.0000E+00 | / |
| R3 | −5.1254E−01 | 0.0000E+00 | 0.0000E+00 | 0.0000E+00 | 0.0000E+00 | / |
| R4 | −9.1475E−02 | 0.0000E+00 | 0.0000E+00 | 0.0000E+00 | 0.0000E+00 | / |
| R5 | 9.7886E+01 | 0.0000E+00 | 0.0000E+00 | 0.0000E+00 | 0.0000E+00 | / |
| R6 | 1.1659E+01 | 0.0000E+00 | 0.0000E+00 | 0.0000E+00 | 0.0000E+00 | / |
| R7 | −8.4469E−01 | 0.0000E+00 | 0.0000E+00 | 0.0000E+00 | 0.0000E+00 | / |
| R8 | 1.0117E+03 | 0.0000E+00 | 0.0000E+00 | 0.0000E+00 | 0.0000E+00 | / |
| R9 | −1.2442E+00 | 7.1732E−08 | −4.4705E−09 | 1.5434E−10 | −2.2709E−12 | / |
| R10 | −2.8692E+01 | −2.1304E−10 | 1.1329E−11 | −2.5378E−13 | 2.1527E−15 | / |
| R11 | −6.2557E+00 | −1.0998E−12 | 5.2099E−15 | 7.9315E−16 | −1.3185E−17 | / |
| R12 | −1.1420E+00 | −3.4777E−12 | 8.1476E−14 | −1.0963E−15 | 6.5148E−18 | / |
| R13 | −1.0994E+00 | 9.1400E−14 | −1.0000E−15 | 5.6762E−18 | −9.9560E−21 | / |
| R14 | −9.9551E−01 | −3.7029E−13 | 4.4349E−15 | −3.1591E−17 | 1.0137E−19 | / |

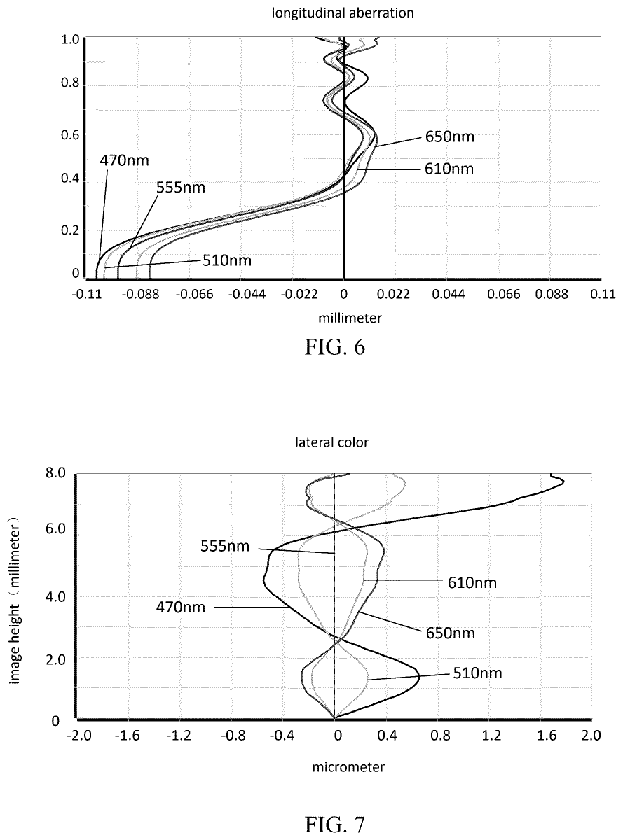

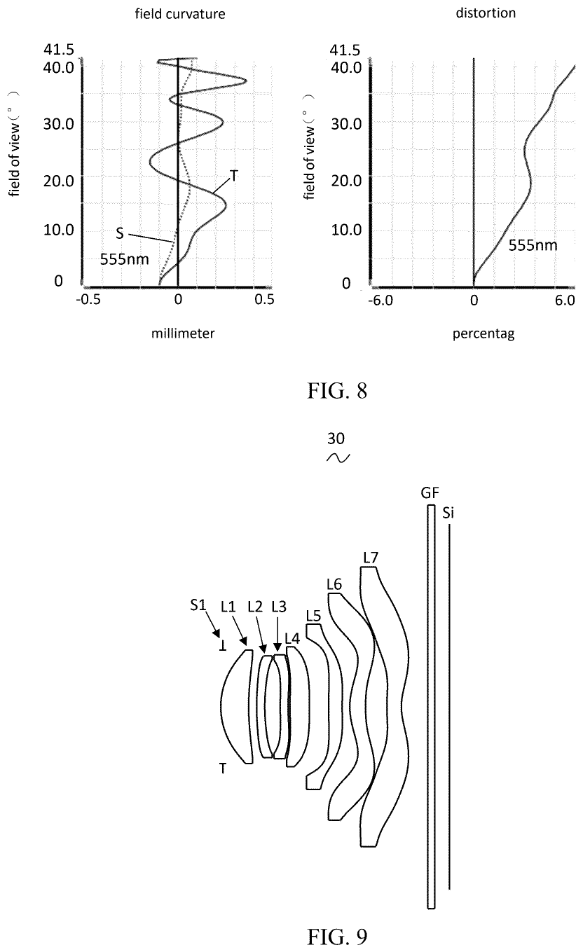

FIG. 6 and FIG. 7 respectively show longitudinal aberration and lateral color of light with wavelengths of 650 nm, 610 nm, 555 nm, 510 nm, and 470 nm after passing through the camera optical lens 20 according to Embodiment 2. FIG. 8 shows field curvature and distortion of light with a wavelength of 555 nm after passing through the camera optical lens 20 according to Embodiment 2. The field curvature S in FIG. 8 is the field curvature in the sagittal direction, and T is the field curvature in the meridian direction.

In this embodiment, the entrance pupil diameter ENPD of the camera optical lens 20 is 5.077 mm, the full field of view (1.0 field of view) image height IH is 8.000 mm, the field of view FOV of the full field of view (1.0 field of view) in a diagonal direction is 83.00°, the MIC field of view image height IH is 8.290 mm, the field of view FOV in a diagonal direction of the MIC field of view is 84.97°, the camera optical lens 20 meets the design requirements of small aberration, high image quality, good processability and convenient adjustment of later image distortion. Its on-axis and off-axis chromatic aberrations are sufficiently corrected. The camera optical lens 20 has excellent optical characteristics.

### Embodiment 3

The meaning of the reference signs of Embodiment 3 is the same as that of Embodiment 1.

FIG. 9 shows a camera optical lens 30 according to Embodiment 3 of the present disclosure.

Table 5 and Table 6 show design data of the camera optical lens 30 according to the Embodiment 3 of the present disclosure.

TABLE 5

| | R | d | | nd | | νd | |
|---|---|---|---|---|---|---|---|
| S1 | ∞ | d0= | −0.090 | | | | |
| R1 | 3.425 | d1= | 1.237 | nd1 | 1.4959 | ν1 | 81.64 |
| R2 | 10.542 | d2= | 0.355 | | | | |
| R3 | 10.949 | d3= | 0.363 | nd2 | 1.6700 | ν2 | 19.39 |
| R4 | 8.508 | d4= | 0.687 | | | | |
| R5 | 32.221 | d5= | 0.350 | nd3 | 1.6700 | ν3 | 19.39 |
| R6 | 12.555 | d6= | 0.082 | | | | |
| R7 | 26.253 | d7= | 0.863 | nd4 | 1.5444 | ν4 | 55.82 |
| R8 | −35.527 | d8= | 0.852 | | | | |
| R9 | 23.179 | d9= | 0.600 | nd5 | 1.5661 | ν5 | 37.71 |
| R10 | 11.503 | d10= | 0.338 | | | | |
| R11 | 3.088 | d11= | 0.700 | nd6 | 1.5444 | ν6 | 55.69 |
| R12 | 9.266 | d12= | 0.946 | | | | |
| R13 | 7.831 | d13= | 0.642 | nd7 | 1.5346 | ν7 | 55.69 |
| R14 | 2.526 | d14= | 1.177 | | | | |
| R15 | ∞ | d15= | 0.310 | ndg | 1.5168 | νg | 64.17 |
| R16 | ∞ | d16= | 0.647 | | | | |

Table 6 shows aspheric surface data of each lens in the camera optical lens 30 according to Embodiment 3 of the present disclosure.

TABLE 6

| | Conic Coefficient | Conic Coefficient | | | | |
|---|---|---|---|---|---|---|
| | k | A4 | A6 | A8 | A10 | A12 |
| R1 | −1.2230E+00 | 3.4688E−03 | 6.0291E−04 | −4.7214E−04 | 2.8490E−04 | −1.0989E−04 |
| R2 | −2.9883E+00 | −2.5443E−03 | −1.0106E−03 | 1.3530E−03 | −9.4613E−04 | 3.9773E−04 |
| R3 | 2.1102E+00 | −6.5441E−03 | 3.0600E−05 | 1.3148E−03 | −8.5500E−04 | 3.6580E−04 |
| R4 | 6.3815E+00 | −5.8280E−03 | 1.8891E−03 | −1.8388E−03 | 2.0261E−03 | −1.2174E−03 |
| R5 | 1.6332E+00 | −1.0313E−02 | −6.9214E−04 | −1.9909E−03 | 2.5006E−03 | −1.6858E−03 |
| R6 | −2.1049E+01 | −1.6552E−03 | −1.1794E−02 | 6.8665E−03 | −2.3222E−03 | 3.4117E−04 |
| R7 | −4.0427E+01 | −2.4128E−03 | 7.1682E−05 | −2.3560E−02 | 4.2937E−02 | −4.3801E−02 |
| R8 | 3.6374E+01 | −5.3347E−03 | −9.7428E−03 | 1.9115E−02 | −2.5501E−02 | 2.2279E−02 |
| R9 | 1.4768E+00 | −1.5597E−02 | 1.0307E−02 | −8.7930E−03 | 6.9814E−03 | −4.4987E−03 |
| R10 | −3.6713E+01 | −5.0533E−02 | 1.9681E−02 | −6.6261E−03 | 1.8336E−03 | −4.2372E−04 |
| R11 | −9.6530E−01 | −2.1674E−02 | 3.9350E−03 | −1.8506E−03 | 4.5657E−04 | −5.6627E−05 |
| R12 | 7.8186E−01 | 2.6790E−02 | −8.5961E−03 | 4.6965E−04 | 3.1332E−04 | −1.0825E−04 |
| R13 | −5.4670E−01 | −4.7580E−02 | 1.1008E−02 | −2.4501E−03 | 4.7572E−04 | −6.6104E−05 |
| R14 | −4.8613E+00 | −3.1597E−02 | 8.1423E−03 | −1.7851E−03 | 2.9972E−04 | −3.7034E−05 |
| | Conic Coefficient | Conic coefficient | | | | |
| | k | A14 | A16 | A18 | A20 | A22 |
| R1 | −1.2230E+00 | 2.7338E−05 | −4.2923E−06 | 3.8471E−07 | −1.5087E−08 | 0.0000E+00 |
| R2 | −2.9883E+00 | −1.0187E−04 | 1.5463E−05 | −1.2711E−06 | 4.3143E−08 | 0.0000E+00 |
| R3 | 2.1102E+00 | −9.6381E−05 | 1.5042E−05 | −1.2580E−06 | 4.3754E−08 | 0.0000E+00 |
| R4 | 6.3815E+00 | 4.3340E−04 | −9.0532E−05 | 1.0220E−05 | −4.7749E−07 | 0.0000E+00 |
| R5 | 1.6332E+00 | 6.4092E−04 | −1.3997E−04 | 1.6449E−05 | −8.0278E−07 | 0.0000E+00 |
| R6 | −2.1049E+01 | 3.5856E−05 | −2.2489E−05 | 3.3298E−06 | −1.7012E−07 | 0.0000E+00 |
| R7 | −4.0427E+01 | 3.0094E−02 | −1.4672E−02 | 5.1730E−03 | −1.3225E−03 | 2.4256E−04 |
| R8 | 3.6374E+01 | −1.3280E−02 | 5.5812E−03 | −1.6827E−03 | 3.6553E−04 | −5.6719E−05 |
| R9 | 1.4768E+00 | 2.1050E−03 | −7.0217E−04 | 1.6757E−04 | −2.8637E−05 | 3.4720E−06 |
| R10 | −3.6713E+01 | 7.9320E−05 | −1.1590E−05 | 1.2818E−06 | −1.0371E−07 | 5.8776E−09 |
| R11 | −9.6530E−01 | 1.7763E−07 | 1.1151E−06 | −1.9170E−07 | 1.7553E−08 | −1.0137E−09 |
| R12 | 7.8186E−01 | 1.8978E−05 | −2.1635E−06 | 1.7076E−07 | −9.5070E−09 | 3.7248E−10 |
| R13 | −5.4670E−01 | 6.3035E−06 | −4.1889E−07 | 1.9760E−08 | −6.6723E−10 | 1.6043E−11 |
| R14 | −4.8613E+00 | 3.3223E−06 | −2.1577E−07 | 1.0147E−08 | −3.4456E−10 | 8.3514E−12 |

| | Conic Coefficient | Conic Coefficient | | | | |
|---|---|---|---|---|---|---|
| | k | A24 | A26 | A28 | A30 | / |
| R1 | −1.2230E+00 | 0.0000E+00 | 0.0000E+00 | 0.0000E+00 | 0.0000E+00 | / |
| R2 | −2.9883E+00 | 0.0000E+00 | 0.0000E+00 | 0.0000E+00 | 0.0000E+00 | / |
| R3 | 2.1102E+00 | 0.0000E+00 | 0.0000E+00 | 0.0000E+00 | 0.0000E+00 | / |
| R4 | 6.3815E+00 | 0.0000E+00 | 0.0000E+00 | 0.0000E+00 | 0.0000E+00 | / |
| R5 | 1.6332E+00 | 0.0000E+00 | 0.0000E+00 | 0.0000E+00 | 0.0000E+00 | / |
| R6 | −2.1049E+01 | 0.0000E+00 | 0.0000E+00 | 0.0000E+00 | 0.0000E+00 | / |
| R7 | −4.0427E+01 | −3.1069E−05 | 2.6358E−06 | −1.3294E−07 | 3.0149E−09 | / |
| R8 | 3.6374E+01 | 6.1307E−06 | −4.3833E−07 | 1.8625E−08 | −3.5588E−10 | / |
| R9 | 1.4768E+00 | −2.9122E−07 | 1.6048E−08 | −5.2200E−10 | 7.5852E−12 | / |
| R10 | −3.6713E+01 | −2.1919E−10 | 4.8071E−12 | −4.6849E−14 | 0.0000E+00 | / |
| R11 | −9.6530E−01 | 3.8118E−11 | −9.0973E−13 | 1.2559E−14 | −7.6564E−17 | / |
| R12 | 7.8186E−01 | −1.0051E−11 | 1.7787E−13 | −1.8587E−15 | 8.6952E−18 | / |
| R13 | −5.4670E−01 | −2.6846E−13 | 2.9737E−15 | −1.9606E−17 | 5.8256E−20 | / |
| R14 | −4.8613E+00 | −1.4080E−13 | 1.5680E−15 | −1.0367E−17 | 3.0801E−20 | / |

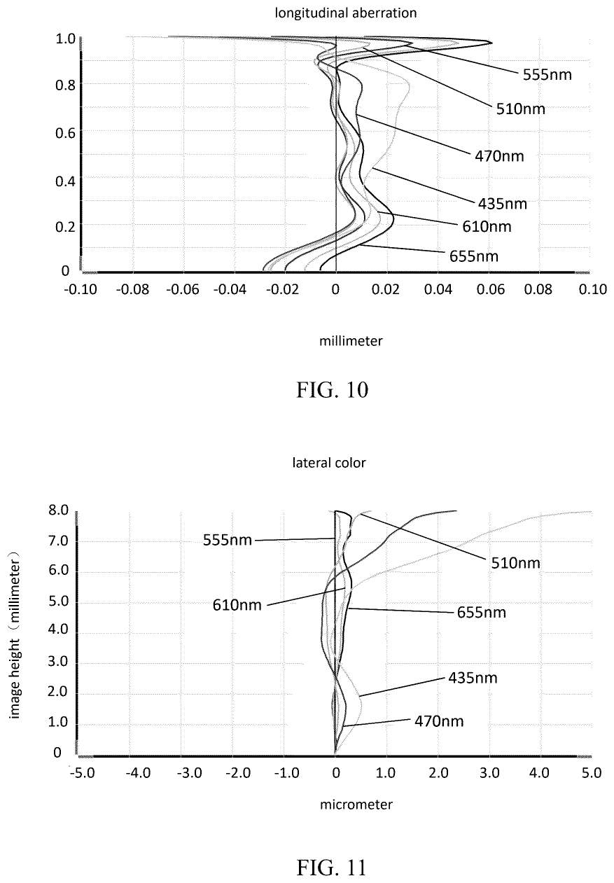

FIG. 10 and FIG. 11 respectively show longitudinal aberration and lateral color of light with wavelengths of 655 nm, 610 nm, 555 nm, 510 nm, 470 nm, and 435 nm after passing through the camera optical lens 30 according to Embodiment 3. FIG. 12 shows field curvature and distortion of light with a wavelength of 555 nm after passing through the camera optical lens 30 according to Embodiment 3. The field curvature S in FIG. 12 is the field curvature in the sagittal direction, and T is the field curvature in the meridian direction.

In this embodiment, the entrance pupil diameter ENPD of the camera optical lens 30 is 5.140 mm, the full field of view (1.0 field of view) image height IH is 8.000 mm, the field of view FOV of the full field of view (1.0 field of view) in a diagonal direction is 85.10°, the MIC field of view image height IH is 8.290 mm, the field of view FOV in a diagonal direction of the MIC field of view is 87.14°, the camera optical lens 30 meets the design requirements of small aberration, high image quality, good processability and convenient adjustment of later image distortion. Its on-axis and off-axis chromatic aberrations are sufficiently corrected. The camera optical lens 30 has excellent optical characteristics.

### Embodiment 4

The meaning of the reference signs of Embodiment 4 is the same as that of Embodiment 1.

FIG. 13 shows a camera optical lens 40 according to Embodiment 4 of the present disclosure.

Table 7 and Table 8 show design data of the camera optical lens 40 according to Embodiment 4 of the present disclosure.

TABLE 7

| | R | d | | nd | | νd | |
|---|---|---|---|---|---|---|---|
| S1 | ∞ | d0= | −0.090 | | | | |
| R1 | 3.421 | d1= | 1.260 | nd1 | 1.4959 | ν1 | 81.64 |
| R2 | 10.860 | d2= | 0.333 | | | | |
| R3 | 10.302 | d3= | 0.350 | nd2 | 1.6700 | ν2 | 19.39 |
| R4 | 8.210 | d4= | 0.729 | | | | |
| R5 | 49.618 | d5= | 0.350 | nd3 | 1.6700 | ν3 | 19.39 |
| R6 | 13.907 | d6= | 0.072 | | | | |
| R7 | 26.263 | d7= | 0.821 | nd4 | 1.5444 | ν4 | 55.82 |
| R8 | −39.142 | d8= | 0.824 | | | | |
| R9 | 30.889 | d9= | 0.600 | nd5 | 1.5661 | ν5 | 37.71 |
| R10 | 7.973 | d10= | 0.175 | | | | |
| R11 | 2.770 | d11= | 0.700 | nd6 | 1.5444 | ν6 | 55.69 |
| R12 | 7.515 | d12= | 0.905 | | | | |
| R13 | 5.229 | d13= | 0.895 | nd7 | 1.5346 | ν7 | 55.69 |
| R14 | 2.422 | d14= | 1.177 | | | | |
| R15 | ∞ | d15= | 0.310 | ndg | 1.5168 | νg | 64.17 |
| R16 | ∞ | d16= | 0.646 | | | | |

Table 8 shows aspheric surface data of each lens in the camera optical lens 40 according to Embodiment 4 of the present disclosure.

TABLE 8

| | Conic Coefficient | Aspheric Coefficient | | | | |
|---|---|---|---|---|---|---|
| | k | A4 | A6 | A8 | A10 | A12 |
| R1 | 0.0000E+00 | −2.0333E−03 | 6.4959E−03 | −1.1260E−02 | 1.1646E−02 | −7.7298E−03 |
| R2 | −3.2271E+00 | −3.0959E−03 | 2.0750E−04 | −6.2202E−05 | 2.1161E−05 | −1.7743E−06 |
| R3 | 2.1109E+00 | −6.4529E−03 | −7.2867E−04 | 2.7346E−03 | −2.1413E−03 | 1.0380E−03 |
| R4 | 6.3816E+00 | −5.0921E−03 | −5.3742E−04 | 1.9526E−03 | −1.3270E−03 | 5.6902E−04 |
| R5 | 8.7378E+01 | −8.8947E−03 | −4.0429E−03 | 2.1987E−03 | −8.6256E−04 | 2.9082E−05 |
| R6 | −1.9900E+01 | −1.2024E−03 | −1.2182E−02 | 7.6176E−03 | −3.0090E−03 | 6.6694E−04 |
| R7 | −3.9954E+01 | −2.2056E−03 | −1.9644E−03 | −1.3962E−02 | 2.6142E−02 | −2.5831E−02 |
| R8 | −7.6873E+01 | −7.4197E−03 | −4.4943E−03 | 8.9604E−03 | −1.2815E−02 | 1.1892E−02 |
| R9 | −5.3305E+01 | −1.2786E−02 | 1.1431E−02 | −1.1808E−02 | 9.2421E−03 | −5.3182E−03 |
| R10 | −4.8861E+01 | −4.6245E−02 | 1.5176E−02 | −5.3344E−03 | 2.0871E−03 | −7.3848E−04 |
| R11 | −9.8247E−01 | −2.4027E−02 | 4.1572E−03 | −1.4306E−03 | 1.3633E−04 | 5.1919E−05 |
| R12 | 5.2721E−01 | 2.5608E−02 | −6.7288E−03 | −4.8472E−04 | 5.6451E−04 | −1.5088E−04 |
| R13 | −1.0648E+00 | −4.9849E−02 | 9.2034E−03 | −1.7183E−03 | 3.6065E−04 | −5.7857E−05 |
| R14 | −4.0920E+00 | −3.0367E−02 | 6.8789E−03 | −1.3584E−03 | 2.1063E−04 | −2.4054E−05 |
| | Conic Coefficient | Aspheric Coefficient | | | | |
| | k | A14 | A16 | A18 | A20 | A22 |
| R1 | 0.0000E+00 | 3.4301E−03 | −1.0392E−03 | 2.1561E−04 | −3.0126E−05 | 2.7092E−06 |
| R2 | −3.2271E+00 | −1.1923E−06 | 3.7357E−07 | −4.2620E−08 | 1.5669E−09 | 0.0000E+00 |
| R3 | 2.1109E+00 | −3.0861E−04 | 5.4964E−05 | −5.3749E−06 | 2.2271E−07 | 0.0000E+00 |
| R4 | 6.3816E+00 | −1.5030E−04 | 2.3617E−05 | −2.0036E−06 | 7.1573E−08 | 0.0000E+00 |
| R5 | 8.7378E+01 | 9.7863E−05 | −3.6878E−05 | 5.7361E−06 | −3.3628E−07 | 0.0000E+00 |
| R6 | −1.9900E+01 | −5.4346E−05 | −7.7147E−06 | 2.0017E−06 | −1.1969E−07 | 0.0000E+00 |
| R7 | −3.9954E+01 | 1.7022E−02 | −7.9736E−03 | 2.7159E−03 | −6.7499E−04 | 1.2104E−04 |
| R8 | −7.6873E+01 | −7.4507E−03 | 3.2696E−03 | −1.0250E−03 | 2.3089E−04 | −3.7075E−05 |
| R9 | −5.3305E+01 | 2.2133E−03 | −6.6984E−04 | 1.4812E−04 | −2.3870E−05 | 2.7667E−06 |
| R10 | −4.8861E+01 | 1.9702E−04 | −3.7412E−05 | 4.9781E−06 | −4.5833E−07 | 2.8513E−08 |
| R11 | −9.8247E−01 | −2.2220E−05 | 4.2054E−06 | −4.8724E−07 | 3.7403E−08 | −1.9479E−09 |
| R12 | 5.2721E−01 | 2.4149E−05 | −2.6382E−06 | 2.0455E−07 | −1.1364E−08 | 4.4929E−10 |
| R13 | −1.0648E+00 | 6.2640E−06 | −4.6350E−07 | 2.4048E−08 | −8.8712E−10 | 2.3233E−11 |
| R14 | −4.0920E+00 | 1.9661E−06 | −1.1382E−07 | 4.6355E−09 | −1.3090E−10 | 2.4800E−12 |

| | Conic Coefficient | Aspheric Coefficient | | | | |
|---|---|---|---|---|---|---|
| | k | A24 | A26 | A28 | A30 | / |
| R1 | 0.0000E+00 | −1.4157E−07 | 3.2647E−09 | 0.0000E+00 | 0.0000E+00 | / |
| R2 | −3.2271E+00 | 0.0000E+00 | 0.0000E+00 | 0.0000E+00 | 0.0000E+00 | / |
| R3 | 2.1109E+00 | 0.0000E+00 | 0.0000E+00 | 0.0000E+00 | 0.0000E+00 | / |
| R4 | 6.3816E+00 | 0.0000E+00 | 0.0000E+00 | 0.0000E+00 | 0.0000E+00 | / |
| R5 | 8.7378E+01 | 0.0000E+00 | 0.0000E+00 | 0.0000E+00 | 0.0000E+00 | / |
| R6 | −1.9900E+01 | 0.0000E+00 | 0.0000E+00 | 0.0000E+00 | 0.0000E+00 | / |
| R7 | −3.9954E+01 | −1.5232E−05 | 1.2746E−06 | −6.3619E−08 | 1.4313E−09 | / |
| R8 | −7.6873E+01 | 4.1408E−06 | −3.0555E−07 | 1.3387E−08 | −2.6357E−10 | / |
| R9 | −5.3305E+01 | −2.2413E−07 | 1.2019E−08 | −3.8247E−10 | 5.4577E−12 | / |
| R10 | −4.8861E+01 | −1.1423E−09 | 2.6592E−11 | −2.7333E−13 | 0.0000E+00 | / |
| R11 | −9.8247E−01 | 6.8328E−11 | −1.5500E−12 | 2.0579E−14 | −1.2162E−16 | / |
| R12 | 5.2721E−01 | −1.2342E−11 | 2.2400E−13 | −2.4171E−15 | 1.1753E−17 | / |
| R13 | −1.0648E+00 | −4.2325E−13 | 5.1099E−15 | −3.6812E−17 | 1.1994E−19 | / |
| R14 | −4.0920E+00 | −2.9271E−14 | 1.7647E−16 | −1.0996E−19 | −3.0300E−21 | / |

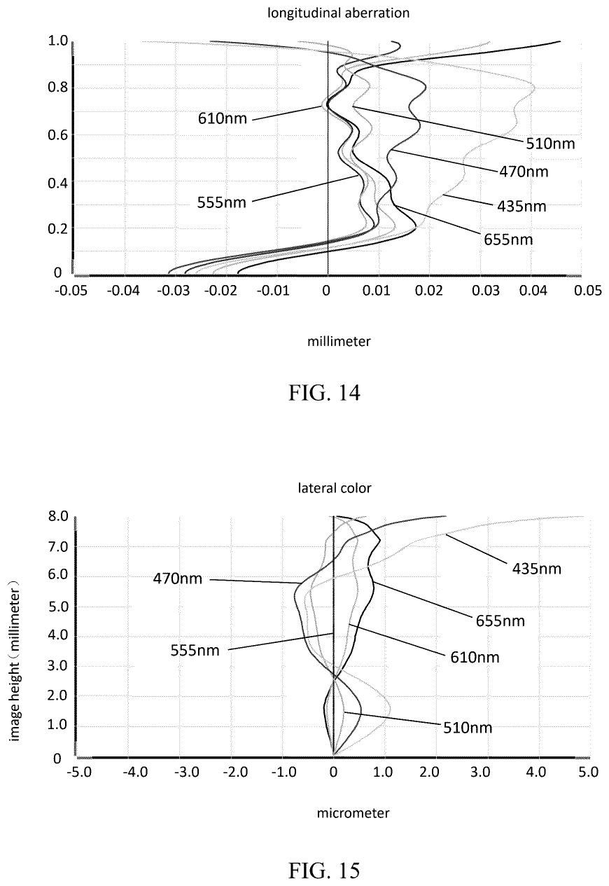

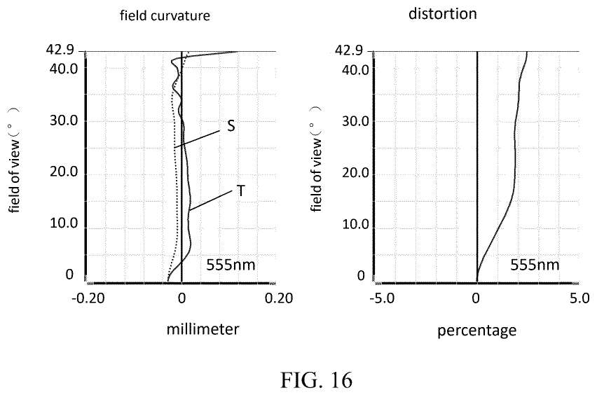

FIG. 14 and FIG. 15 respectively show longitudinal aberration and lateral color of light with wavelengths of 655 nm, 610 nm, 555 nm, 510 nm, 470 nm, and 435 nm after passing through the camera optical lens 40 according to Embodiment 4. FIG. 16 shows field curvature and distortion of light with a wavelength of 555 nm after passing through the camera optical lens 40 according to Embodiment 4. The field curvature S in FIG. 16 is the field curvature in the sagittal direction, and T is the field curvature in the meridian direction.

In this embodiment, the entrance pupil diameter ENPD of the camera optical lens 40 is 5.069 mm, the full field of view (1.0 field of view) image height IH is 8.000 mm, the field of view FOV of the full field of view (1.0 field of view) in a diagonal direction is 85.79°, the MIC field of view image height IH is 8.290 mm, the field of view FOV in a diagonal direction of the MIC field of view is 87.91°, the camera optical lens 40 meets the design requirements of small aberration, high image quality, good processability and convenient adjustment of later image distortion. Its on-axis and off-axis chromatic aberrations are sufficiently corrected. The camera optical lens 40 has excellent optical characteristics.

TABLE 9

| Parameters and | Embodiment | Embodiment | Embodiment | Embodiment |
|---|---|---|---|---|
| Relational Expressions | 1 | 2 | 3 | 4 |
| (DIST0.8H − DIST0.5H)/ | 1.36 | 1.27 | 0.60 | 0.43 |
| (DIST0.5H − DIST0.3H) | | | | |
| (DIST1.0H − DIST0.8H)/ | 0.08 | 1.11 | −0.11 | 2.05 |
| (DIST0.8H − DIST0.6H) | | | | |
| f12345/f67 | 1.97 | 2.04 | 0.28 | 0.99 |
| R13/R14 | 2.08 | 2.05 | 3.10 | 2.16 |
| v1 | 81.65 | 81.65 | 81.64 | 81.64 |
| (R5 + R6)/f | 5.55 | 7.66 | 5.28 | 7.60 |
| ENPD/FOV | 0.06 | 0.06 | 0.06 | 0.06 |
| (R1 + R2)/(R1 − R2) | −2.08 | −1.97 | −1.96 | −1.92 |
| (R3 + R4)/(R3 − R4) | 9.06 | 8.71 | 7.97 | 8.85 |
| R11/R12 | 0.35 | 0.34 | 0.33 | 0.37 |
| (SAG31/SD31*R5)/ | −1.74 | −2.63 | −2.93 | −5.56 |
| (SAG11/SD11*R1) | | | | |
| f | 8.475 | 8.378 | 8.487 | 8.364 |
| f1 | 9.967 | 9.739 | 9.649 | 9.512 |
| f2 | −62.345 | −56.823 | −60.027 | −64.147 |
| f3 | −43.732 | −43.481 | −30.639 | −28.69 |
| f4 | 26.92 | 27.646 | 27.778 | 28.905 |
| f5 | −11.318 | −11.235 | −40.907 | −19.074 |
| f6 | 6.303 | 6.308 | 8.153 | 7.634 |
| f7 | −9.042 | −9.541 | −7.259 | −9.464 |
| FNO | 1.650 | 1.650 | 1.651 | 1.650 |
| TTL | 10.041 | 10.199 | 10.149 | 10.147 |

Those skilled in the art may understand that the above embodiments are specific embodiments for implementing the present disclosure, and in practical applications, various changes may be made in form and detail without departing from the spirit and scope of the present disclosure.

What is claimed is:

1. A camera optical lens, sequentially comprising seven lenses from an object side to an image side: a first lens having positive refractive power, a second lens having negative refractive power, a third lens having negative refractive power, a fourth lens having positive refractive power, a fifth lens having negative refractive power, a sixth lens having positive refractive power, and a seventh lens having negative refractive power;
wherein an object-side surface of the first lens is convex in a paraxial region, an image-side surface of the first lens is concave in the paraxial region; an object-side surface of the second lens is convex in the paraxial region, an image-side surface of the second lens is concave in the paraxial region; an object-side surface of the third lens is convex in the paraxial region, an image-side surface of the third lens is concave in the paraxial region; an object-side surface of the fourth lens is convex in the paraxial region, an image-side surface of the fourth lens is convex in the paraxial region; an image-side surface of the fifth lens is concave in the paraxial region; an object-side surface of the sixth lens is convex in the paraxial region, an image-side surface of the sixth lens is concave in the paraxial region; an object-side surface of the seventh lens is convex in the paraxial region, an image-side surface of the seventh lens is concave in the paraxial region;
wherein a distortion of the camera optical lens at 1.0 field of view is defined as DIST_{1.0H}, a distortion of the camera optical lens at 0.8 field of view is defined as DIST_{0.8H}, a distortion of the camera optical lens at 0.6 field of view is defined as DIST_{0.6H}, a distortion of the camera optical lens at 0.5 field of view is defined as DIST_{0.5H}, a distortion of the camera optical lens at 0.3 field of view is defined as DIST_{0.3H}, a combined focal length of the first lens, the second lens, the third lens, the fourth lens, and the fifth lens is defined as f12345, a combined focal length of the sixth lens and the seventh lens is defined as f67, a central curvature radius of the object-side surface of the seventh lens in the paraxial region is defined as R13, a central curvature radius of the image-side surface of the seventh lens in the paraxial region is defined as R14, an abbe number of the first lens is defined as v1, a central curvature radius of the object-side surface of the third lens in the paraxial region is defined as R5, a central curvature radius of the image-side surface of the third lens in the paraxial region is defined as R6, a focal length of the camera optical lens is f, an entrance pupil diameter of the camera optical lens is defined as ENPD, a field of view of the 1.0 field of view of the camera optical lens is defined as FOV, and following relational expressions are satisfied:
$$0.4 \leq ( {DIST}_{0.8 H} - {DIST}_{0.5 H} ) / ( {DIST}_{0.5 H} - {DIST}_{0.3 H} ) \leq 1.6 ;$$
$$- 0.13 \leq ( {DIST}_{1. H} - {DIST}_{0.8 H} ) / ( {DIST}_{0.8 H} - {DIST}_{0.6 H} ) \leq 2.5 ;$$
$$0.25 \leq f 12345 / f 67 \leq 2.4 ;$$
$$1.6 \leq R 13 / R 14 \leq 3.8 ;$$
$$80. \leq v 1 \leq 82. ;$$
$$4. \leq ( R 5 + R 6 ) / f \leq 9. ; and$$
$$0.05 \leq E N P D / F O V \leq 0.07 .$$

2. The camera optical lens as described in claim 1, wherein a following relational expression is satisfied: 0.40≤(DIST_{0.8H}−DIST_{0.5H})/(DIST_{0.5H}−DIST_{0.3H})≤1.40.

3. The camera optical lens as described in claim 1, wherein a following relational expression is satisfied: −0.12≤(DIST_{1.0H}−DIST_{0.8H})/(DIST_{0.8H}−DIST_{0.6H})≤2.10.

4. The camera optical lens as described in claim 1, wherein a following relational expression is satisfied: 0.25≤f12345/f67≤2.10.

5. The camera optical lens as described in claim 1, wherein a following relational expression is satisfied: 2.00≤R13/R14≤3.20.

6. The camera optical lens as described in claim 1, wherein a following relational expression is satisfied: 5.00≤(R5+R6)/f≤7.80.

7. The camera optical lens as described in claim 1, wherein a maximum optical radius of the object-side surface of the third lens is defined as SD31, a sagittal height at the maximum optical radius of the object-side surface of the third lens is defined as SAG31, a maximum optical radius of the object-side surface of the first lens is defined as SD11, a sagittal height at the maximum optical radius of the object-side surface of the first lens is defined as SAG11, a central curvature radius of the object-side surface of the first lens in the paraxial region is defined as R1, a central curvature radius of the object-side surface of the third lens in the paraxial region is defined as R5, and a following relational expression is satisfied: −6.60≤(SAG31/SD31*R5)/(SAG11/SD11*R1)≤−1.40.

8. The camera optical lens as described in claim 7, wherein a following relational expression is satisfied: −5.80≤(SAG31/SD31*R5)/(SAG11/SD11*R1)≤−1.70.

9. The camera optical lens as described in claim 1, wherein an on-axis thickness of the first lens is d1, an on-axis thickness of the second lens is d3, an on-axis thickness of the seventh lens is d13, and a following relational expression is satisfied:
$$1.45 \leq ( d 1 + d 3 + d 13 ) / d 1 \leq 2.25 .$$

10. The camera optical lens as described in claim 9, wherein a following relational expression is satisfied: 1.63≤(d1+d3+d13)/d1≤2.02.

11. The camera optical lens as described in claim 1, wherein the first lens is made of glass.

12. A lens assembly, comprising the camera optical lens as described in claim 1, wherein the camera optical lens comprises a first lens barrel accommodating the first lens and a second lens barrel accommodating the second lens to the seventh lens.

13. The lens assembly as described in claim 12, wherein the first lens barrel comprises a first top surface adjacent to an object side, the second lens barrel comprises a second top surface adjacent to the object side, an object-side surface of the first lens protrudes from the first top surface toward the object side, a distance between the first top surface and a center of the object-side surface of the first lens along the optical axis is defined as B1, a distance between the second top surface and a center of the object-side surface of the first lens along the optical axis is defined as B2, a central curvature radius of the object-side surface of the first lens in the paraxial region is defined as R1, a focal length of the first lens is defined as f1, and a following relational expression is satisfied: 0.80≤(B1/B2)*(f1/R1)≤1.50.

14. A camera optical lens, sequentially comprising seven lenses from an object side to an image side: a first lens having positive refractive power, a second lens having negative refractive power, a third lens having negative refractive power, a fourth lens having positive refractive power, a fifth lens having negative refractive power, a sixth lens having positive refractive power, and a seventh lens having negative refractive power;
wherein an object-side surface of the first lens is convex in a paraxial region, an image-side surface of the first lens is concave in the paraxial region; an object-side surface of the second lens is convex in the paraxial region, an image-side surface of the second lens is concave in the paraxial region; an object-side surface of the third lens is convex in the paraxial region, an image-side surface of the third lens is concave in the paraxial region; an object-side surface of the fourth lens is convex in the paraxial region, an image-side surface of the fourth lens is convex in the paraxial region; an image-side surface of the fifth lens is concave in the paraxial region; an object-side surface of the sixth lens is convex in the paraxial region, an image-side surface of the sixth lens is concave in the paraxial region; an object-side surface of the seventh lens is convex in the paraxial region, an image-side surface of the seventh lens is concave in the paraxial region;
wherein a distortion of the camera optical lens at 1.0 field of view is defined as DIST_{1.0H}, a distortion of the camera optical lens at 0.8 field of view is defined as DIST_{0.8H}, a distortion of the camera optical lens at 0.6 field of view is defined as DIST_{0.6H}, a distortion of the camera optical lens at 0.5 field of view is defined as DIST_{0.5H}, a distortion of the camera optical lens at 0.3 field of view is defined as DIST_{0.3H}, a combined focal length of the first lens, the second lens, the third lens, the fourth lens, and the fifth lens is defined as f12345, a combined focal length of the sixth lens and the seventh lens is defined as f67, a central curvature radius of the object-side surface of the first lens in the paraxial region is defined as R1, a central curvature radius of the image-side surface of the first lens in the paraxial region is defined as R2, a central curvature radius of the object-side surface of the second lens in the paraxial region is defined as R3, a central curvature radius of the image-side surface of the second lens in the paraxial region is defined as R4, a central curvature radius of the object-side surface of the sixth lens in the paraxial region is defined as R11, a central curvature radius of the image-side surface of the sixth lens in the paraxial region is defined as R12, and following relational expressions are satisfied:
$$0.4 \leq ( {DIST}_{0.8 H} - {DIST}_{0.5 H} ) / ( {DIST}_{0.5 H} - {DIST}_{0.3 H} ) \leq 1.6 ;$$
$$- 0.13 \leq ( {DIST}_{1. H} - {DIST}_{0.8 H} ) / ( {DIST}_{0.8 H} - {DIST}_{0.6 H} ) \leq 2.5 ;$$
$$0.25 \leq f 12345 / f 67 \leq 2.4 ;$$
$$- 2.5 \leq ( R 1 + R 2 ) / ( R 1 - R 2 ) \leq - 1.5 ;$$
$$7. \leq ( R 3 + R 4 ) / ( R 3 - R 4 ) \leq 10. ; and$$
$$0.3 \leq R 11 / R 12 \leq 0.4 .$$

15. The camera optical lens as described in claim 14, wherein a following relational expression is satisfied: 0.40≤(DIST_{0.8H}−DIST_{0.5H})/(DIST_{0.5H}−DIST_{0.3H})≤1.40.

16. The camera optical lens as described in claim 14, wherein a following relational expression is satisfied: −0.12≤(DIST_{1.0H}−DIST_{0.8H})/(DIST_{0.8H}−DIST_{0.6H})≤2.10.

17. The camera optical lens as described in claim 14, wherein a following relational expression is satisfied: 0.25≤f12345/f67≤2.10.

18. The camera optical lens as described in claim 14, wherein a following relational expression is satisfied: −2.10≤(R1+R2)/(R1−R2)≤−1.90.

19. The camera optical lens as described in claim 14, wherein a following relational expression is satisfied: 7.80≤(R3+R4)/(R3−R4)≤9.20.

20. The camera optical lens as described in claim 14, wherein a sum of lengths of air gaps between any two adjacent lenses among the first lens to the seventh lens on the optical axis is defined as Σd, a total optical length from the object-side surface of the first lens to an image surface of the camera optical lens along an optic axis of the camera optical lens is defined as TTL, and a following relational expression is satisfied:
$$0.25 \leq Σ d / T T L \leq 0.37 .$$

21. The camera optical lens as described in claim 20, wherein a following relational expression is satisfied: 0.28≤Σd/TTL≤0.33.

22. The camera optical lens as described in claim 14, wherein the first lens is made of glass.

23. A lens assembly, comprising the camera optical lens as described in claim 14, wherein the camera optical lens comprises a first lens barrel accommodating the first lens and a second lens barrel accommodating the second lens to the seventh lens.

24. The lens assembly as described in claim 23, wherein the first lens barrel comprises a first top surface adjacent to an object side, the second lens barrel comprises a second top surface adjacent to the object side, an object-side surface of the first lens protrudes from the first top surface toward the object side, a distance between the first top surface and a center of the object-side surface of the first lens along the optical axis is defined as B1, a distance between the second top surface and a center of the object-side surface of the first lens along the optical axis is defined as B2, a central curvature radius of the object-side surface of the first lens in the paraxial region is defined as R1, a focal length of the first lens is defined as f1, and a following relational expression is satisfied: 0.80≤(B1/B2)*(f1/R1)≤1.50.
